(19) United States
(12) Patent Application Publication
(10) Pub. No.: US 2004/0022322 A1
(43) Pub. Date: Feb. 5, 2004

(54) Assigning prioritization during encode of independently compressed objects

(75) Inventor: Thomas A. Dye, Austin, TX (US)

Correspondence Address: Jeffrey C. Hood, Meyertons, Hood, Kivlin, Kowert & Goetzel PC, P.O. Box 398, Austin, TX, 78767, US

(73) Assignee: Meetrix Corporation, Houston, TX

(21) Appl. No.: 10/620,684

(22) Filed: Jul. 16, 2003

Related U.S. Application Data
(60) Provisional application No. 60/397,192, filed on Jul. 19, 2002.

(51) Int. Cl. H04N 7/12

(52) U.S. Cl. 375/240.26; 375/240.16

(57) ABSTRACT

A method and process used to improve the quality of multi participant video conferencing over Internet protocol which uses a unique feedback control loop to dynamically adjust for transport discrepancies commonly found in standard IP networks. The bit-rate of compressed video is adjusted by the limitation of data transport thru the network. Decimation of compressed objects represented by spatial and temporal sub bands of information during times of long latency or limited bandwidth are used to reduce the transmit bit-rate. Wavelet transforms are used for the derivation of spatial and temporal sub-band. Linear summation of decompressed sub-bands during the Inverse wavelet transform allows a quality of image based on the number of object or frame sub-bands received per given frame time. Error signals are developed based on the expected sub-band transport and the actual received number of sub-bands. The encoder to decimate future sub-band transmission during periods of poor network transport or response uses this error signal. Likewise, the error signal can be used to increase the sub-band transmission during periods when the transport and network response meet the desired quality goals of the decoder. Multiple sub-band decimation allows each receiver to have independent image quality that is dynamically adjusted for each transport stream. The error signal is accomplished by measurement of the expected sub-bands to the received sub-bands over an average time period the encoder can adjust the transport information to dynamically increase or reduce the bit-rate based on transport medium and network response. Thus, the method of determining the decimation of sub-bands is based on the network response of previous compressed object transport information allows for dynamic quality of service adjustment for multiple transport streams from a single encoder.

### PRIORITY CLAIM

This application claims benefit of priority of U.S. provisional application Serial No. 60/397,192 titled “ASSIGNING PRIORITIZATION DURING ENCODE OF INDEPENDENTLY COMPRESSED OBJECTS” filed Jul. 19, 2002, whose inventor is Thomas A. Dye which is hereby incorporated by reference in its entirety.

### FIELD OF INVENTION

The present invention relates to computer system and video encoding and decoding system architectures, and more particularly to video telecommunications used for remote collaboration over IP networks. More specifically, the invention generally relates to effective transport of audio and video over IP networks, including compensation for the variance in latency and bandwidth in a packet based network protocol.

### DESCRIPTION OF THE RELATED ART

Since their introduction in the early 1980's, video conferencing systems have enabled users to communicate between remote sites, typically using telephone or circuit switched networks. Recently, technology and products to achieve the same over Internet Protocol (IP) have been attempted. Unlike the telephone networks, which are circuit switched networks with direct point to point connections between users, IP networks are packet switched networks. In a packet switched network, the information being transmitted over the medium is partitioned into packets, and each of the packets is transmitted independently over the medium. In many cases, packets in a transmission take different routes to their destination and arrive at different times, often out of order. In addition, the bandwidth of a packet switched network dynamically changes based on various factors in the network.

Many systems which attempt to perform video conferencing over IP networks have emerged in the marketplace. Currently, most IP-based systems produce low-frame-rate, low resolution and low quality video communications due to the nature of the unpredictable Internet connections. In general, Internet connections have been known to produce long latencies and to limit bandwidth. Therefore most video conferencing solutions have relied on dedicated switched networks such as T1/T3, ISDN or ATM. Theses systems have the disadvantage of higher cost and higher complexity. High costs are typically associated with expensive conferencing hardware and per minute charges associated with dedicated communications circuits. These systems have dedicated known bandwidth and latency and therefore do not require dynamic adaptive control for real time audio and video communication.

Prior art videoconferencing systems which utilize IP networks have not had the ability to dynamically adjust operations to compensate for restrictions in the network latency and bandwidth. Therefore, it is desirable to have a system that address these restrictions. It is desirable to have a system that mitigates costs, reduces transport complexities, improves video resolutions and frame-rates, and runs over standard IP networks while maintaining full duplex real-time communications.

Designers and architects often experience problems associated with IP networks due to the lack of consistent data rates and predictable network latencies. The industry has developed communication technologies such as H.323 to smooth out some of the problems associated with video based conferencing solutions. For quality reasons the H.323 specification is typically used over ISDN, T1 or T3 switched networks. Systems which utilize H.323 are adequate for conference room audio and video collaboration, but require a higher consistent bandwidth. In current technology, these systems can be considered high bandwidth solutions.

According to Teliris Interactive in an April 2001 survey on videoconferencing, 70 percent of end users do not feel videoconferencing has been successful in their organizations. Also, 65 percent of end users have not been able to reduce travel as result of such video collaboration. In all cases, end users report that they require specific support staff to set up multiparty bridge calls. In addition, over half the users find it difficult to see and hear all participants in the video conference. In short, prior art technology has not delivered long distance audio, video and data collaboration in a user-friendly manner. Most end users resorted to the telephone to complete the communication when the video collaboration system failed to deliver. This becomes especially true when video and audio collaboration are conducted over non-dependable IP networks.

Traditionally, full duplex video communications has been accomplished using compression techniques that are based on discrete cosine transforms. Discrete cosine transforms have been used for years for lossy compression of media data. Motion video compression standards such as MPEG (ISO/IEC-11172), MPEG-2 (ISO/IEC-13818), and MPEG-4 (ISO/IEC-14496) use discrete cosine transforms to transform time domain data into the frequency domain. Frequency domain components of the data can be isolated as redundant or insignificant to image re-creation and can be removed from the data stream. Discrete cosine transforms (DCT) are inherently poor when dynamically reducing the bandwidth requirements on a frame by frame basis. The DCT operation is better suited for a constant bandwidth pipe when real-time data transport is required. Most often, data reduction is accomplished through the process of quantization and encoding after the data has been converted to the frequency domain by the DCT operation. Because the MPEG standard is designed to operate on blocks in the image (typically 8×8 or 16×16 pixel blocks, called macro blocks) these adjustments which are made to the transform coefficients can cause the reproduction of the image to look blocky under low-bit-rate or inconsistent transport environments. These situations usually increase noise, resulting in lower signal to noise ratios between the original and decompressed video streams.

In addition, prior art systems are known to reduce spatial and temporal resolutions, color quantization levels and reduce the number of intra-frames (I-Frames) to compensate for low-bit-rate throughput during channel transport. Changing spatial resolutions (typically display window size) does not readily allow dynamic bandwidth adjustment because the user window size can not vary dynamically on a frame by frame basis. High color quantization or the reduction of intra-frames can be used to adjust bit-rates, but at the sacrifice of image quality. Temporal reductions, such as frame dropping, are common and often cause “jerky” video.

Thus, it is desired to encode data for transport where the bit-rate can be dynamically adjusted to maintain a constant value without substantial loss of image quality, resolution and frame rate. Such a system is desirable in order to compensate for network transport inconsistencies and deficiencies.

Recently, the use of discrete wavelet transforms (DWTs) has proven more effective in image quality reproduction. Wavelet technology has been used to deliver a more constant bit rate and predictable encoding and decoding structure for such low bit rate error-prone transports. However, the DWT has lagged behind MPEG solutions for low-bit-rate transport. Discrete wavelet transforms, when used for video compression, have numerous advantages over Discrete Cosine Transforms, especially when used in error prone environments such as IP networks. One advantage is that sub band filters used to implement wavelets operate on the whole image, resulting in fewer artifacts (reduced blockiness) than in block-coded images. Another advantage of sub band coding is the robustness under transmission or decoding of errors because errors may be masked by the information on other sub bands.

In addition to higher quality, discrete wavelet transforms have the added ability to decimate information dynamically during multi-frame transport. For example, two-dimensional wavelet transforms (2D-DWT) are made up of a number of independent sub bands. Each sub-band is independently transformed in the spatial domain, and for 3D-DWT, in the temporal domain to reduce the amount of information during compression. In order to reduce information to be transported, spatial sub-bands are simply reduced in quantity. High frequency bands are reduced first while low frequency bands are reduced last. By the elimination of sub-band information during transport, discrete wavelet transforms can dynamically compensate for changes in the IP network environment.

Prior art systems have not provided the capability to regulate changes within the transport medium, e.g., during DWT compression. It would be desirable to provide a system which dynamically compensates for changes within the transport medium, such as in a packet-based network with dynamically varying latency and bandwidth.

Videoconferencing systems of the prior art have primarily been based on the use of decoder and encoder technology. Multiple studies have been performed which involve controlling the bit rate for the encoder.

U.S. Pat. No. 5,617,150 to Nam et al titled “Video Bit Rate Control Method” teaches a method of grouping frames and indicating an abort to the decoder of predictive and interpolates frames when a change in scene is detected at the encoder. In such prior art the decoder stops further decode as a function of the encoder determination of a change in scene. A changed scene, in prior art, can be defined as an energy threshold with high signature difference from previous frames in a temporal fashion. Thus, Nan teaches the use of reducing transport data by indicating to the decoder to abort decoder predictive and interpretive frames.

The known prior art primarily is based on predicting changes in scene which result in high energy changes and thus require larger bit rate transport requirements.

U.S. Pat. No. 6,215,820 to Bagni et al titled “Constant Bit Rate Control In A Video Encode Or A Way Of Pre Analysis Of A Slice Of The Pictures” teaches the use of constant bit rate control for a video encoder based on pre-analysis of a slice of multiple pictures. Thus, the decoder is not used to determined feedback variables interpreted by the encoder to improve quality of service during transport. Instead, the pre-analysis of multiple image slices is used to compensate for variance in bit rate transport at the encoder.

U.S. Pat. No. 5,995,151 to Naveen et al, titled “Bit Rate Control Mechanism For Digital Image And Video Data Compression” teaches a control rate mechanism to control the bit rate of digital images. The Naveen system estimates complexity in the current picture using a block methodology. Multiple blocks of samples are used to derive a complexity factor. The complexity factor is used to indicate a quality factor and is applied to a quantizer during compression. Such prior art is used to adjust the bit rate for transport at the encoder, again based on pre-analysis of the image prior to encoding.

Wavelet based data compression lends itself well to the adjustment of fixed bit rate transport. U.S. Pat. No. 5,845,243 to Smart et al, titled “Method And Apparatus For Wavelet Based Data Compression Having Adaptive Bit Rate Control For Compression Of Audio Information” teaches a method and apparatus using wavelets to approximate a psychoacoustic model for wavelet packet decomposition. Smart shows a bit rate control feedback loop which is particularly well-suited to matching output bit rate of the data compressor to the bandwidth capacity of the communication channel. In such prior art a control parameter is used to eliminate wavelet coefficients in order to achieve the average desired bit rate. This prior art again shows a predicted transport reduction and is controlled at the encoder. Smart does indicate the use of the calculated transport bandwidth in the communication channel in order to determine the amount of wavelet coefficients to eliminate.

Other prior art such as U.S. Pat. No. 5,689,800 to Downs et al titled “Video Feedback For Reducing Data Rate Or Increasing Quality In A Video Processing System” Downs teaches a video feedback mechanism for reducing data rate and increasing quality at the client decoder. Downs teaches how adjustments to the windowing system at the decoder can be used by the encoder to reduce the encoder bit rate. Changes in window size, resolution or color are fed back to the encoder in compensation parameters over Internet protocol networks for bit rate adjustment and compensation. However, Downs does not teach the use of frame rate decode for adjustment parameters used by the encoder for optimal bit rate transport.

In other prior art systems, bit rate inflow control is mandatory for streaming video from a server system to a client. U.S. Pat. No. 6,292,834 to Ravi et al titled “Dynamic Bandwidth Selection For Efficient Transmission Of Multimedia Streams In The Computer Network” teaches the use of output buffers for rate control to compensate for latency and delay during Internet network transport. Such prior art is used primarily for flow control of one-way video and audio. Thus, the teachings of Ravi do not apply to a full duplex video system.

U.S. Pat. No. 6,055,268 to Timm et al titled “Multimode Digital Modem teaches a technique which involves insertion of a filter that acts as a direct equalizer adaptive filter in the transmission path to compensate for frequency distortion of the communication channel. This operation is intended to compensate for distortion within the transport channel and not at the encoder or decoder ends.

As indicated, the prior art does not teach the use of a dynamic measurement of the capability of the decoder to decode and present audio and video data at the desired frame rate. Therefore is desirable to measure the decoder decode rate and compare that to the desired encode rate. It would be desirable to use feedback from the decoder to the encoder to adjust the bit rate to compensate for multiple attributes of the system.

### SUMMARY OF THE INVENTION

One embodiment of the invention comprises a system and method to enhance the quality of service during the transmission of compressed video objects over networks. Embodiments of the invention are particularly applicable for networks with dynamically varying bandwidth and/or latency, such as IP networks.

The system may include a video encoding system executing an encoding process and a client-end decoder system executing a decoding process. The client-end decoder process determines parameters of the network connection, such as current or predicted bandwidth and/or latency, and provides this information to the encoding process. Thus the client-end decoder process may determine the network restrictions impacting video frame rate and may communicate this information back through the network indicating the frame rate capacity to the video object encoder. In one embodiment, the decoder may operate to predict future network parameters and provide these to the encoder for use. Alternatively, the decoder may transmit network parameters indicating current conditions, and the encoder may operate to predict future network parameters for use in the encoding process.

The decoder thus provides dynamic feedback to the encoder regarding the network connection. The encoder can use this information to set the rank and prioritization of independent objects to be compressed by the video encoder. In one embodiment, the encoder may operate to transmit compressed objects at varying rates and/or with varying amounts of compression, based at least in part on the network parameters received from the decoder. For example, when the received network parameters indicate that network bandwidth has increased (or will increase) and/or transfer latency has decreased (or will decrease), the encoder may operate to transmit a greater number of compressed objects and/or may operate to transmit compressed objects with a reduced amount of compression, thus taking advantage of this greater bandwidth and/or reduced latency. When the received network parameters indicate that network bandwidth has decreased (or will decrease) and/or transfer latency has increased (or will increase), the encoder may operate to transmit a lesser number of compressed objects and/or may operate to transmit compressed objects with a greater amount of compression, thus compensating for this reduced bandwidth and/or increased latency.

In one embodiment, the encoder operates to prioritize objects based on their relative depth or z distance in the image. For example, foreground objects may be given higher priority than background objects. The received network parameters indicating network status may be used to determine the amount of information that can be transmitted, and hence which higher priority objects can be transmitted and/or at what level of compression.

By limiting the lower priority independent compressed objects from entering the network, the amount of transmitted information is reduced. Thus, by the reduction or elimination of low priority video objects, increased decoder frame-rate and quality are achieved. The encoder may rank and prioritize independent objects prior to compression. In addition, the encoder determines which of the independent objects to cull from the input data-stream. Thus, objects are independently encoded and compressed for transmission over an IP network using quality of service feedback information from the compressed object decoder.

Thus the system operates to compensate for changes in the network by introduction of dynamic changes to the compression and decompression streams based on the information in the feedback control. The system may achieve a real-time dynamically compensating transport mechanism. In one embodiment, the system uses multiple DWTs in both the 2D and 3D domains in conjunction with a novel control system algorithm. Thus, embodiments of the invention may actively compensate for network anomalies by altering the flow rate of independently compressed video object sub-bands for transport over IP networks.

### BRIEF DESCRIPTION OF THE DRAWINGS

A better understanding of the present invention can be obtained when the following detailed description of the preferred embodiment is considered in conjunction with the following drawings, in which:

FIG. 1 illustrates a network based video collaboration system according to one embodiment of the invention;

FIG. 2 is a high-level block diagram illustrating an embodiment of the present invention;

FIG. 3 illustrates the Internet bit rate control flow diagram of one embodiment;

FIG. 4 illustrates a high-level block diagram of the feedback mechanism between the encoder and decoder;

FIG. 5 illustrates a detailed block diagram of the encoder rate and control process of one embodiment;

FIG. 6 illustrates the decoder threshold procedures in order to control encoder bit rate.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENT

Various embodiments of a novel video communication system are disclosed. Embodiments of the video communication system employ improved compression and decompression techniques to greatly improved quality and reliability in the system.

One embodiment of the present invention uses a novel feedback mechanism between the video encoder and preferably a remotely located video decoder. The feedback mechanism is used to compensate for limitations of networks with dynamically varying bandwidth and/or latency, such as Internet IP networks. One embodiment of the method provides compensation for a dynamically changing transport network, i.e., the method enables the encoder to transmit a greater amount of information when network bandwidth increases, and transmit a lesser amount of information when network bandwidth decreases.

Embodiments of the invention may be useful in all areas of noisy or uncontrolled digital network transport of video and audio information. Embodiments of the invention may be used wherein the encoder system allows dynamic control of the bit rate prior to transport. In one embodiment, the encoding system uses an encoding methodology such as that disclosed in U.S. patent application Ser. No. ______ titled: “Transmission of Independently Compressed Video Objects over Internet Protocol” and filed on May 28, 2003, whose inventor is Thomas A. Dye, which is hereby incorporated by reference as though fully and completely set forth herein.

One embodiment of the present invention includes a novel technique to sub segment objects both in spatial (2-D), Volumetric (3-D), and temporal domains using a unique depth sensing apparatus. These techniques operate to determine individual object boundaries in spatial format without significant computation.

Compressed image objects may then be transferred at varying rates and with varying amounts of compression, dependent on the relative depth of the object in the scene and/or the current amount (or predicted amount) of available bandwidth. For example, foreground objects can be transferred at a greater rate than background objects. Also, image objects may have a greater or lesser amount of compression applied dependent on their relative depth in the scene. Again, foreground objects can be compressed to a lesser degree than background objects, i.e., foreground objects can be compressed whereby they include a greater number of sub bands, and background objects can be compressed whereby they include a lesser number of sub bands.

One embodiment of the present invention also comprises using object boundaries for the decomposition of such objects into multiple 2-D sub bands using wavelet transforms. Further, hierarchical tree decomposition methods may be subsequently used for compression of relevant sub bands. Inverse wavelet transforms may then be used for the recomposition of individual objects that are subsequently layered by an object decoder in a priority fashion for final redisplay.

In some embodiments, the techniques described herein allow for bit rate control and ease of implementation over the prior art. Embodiments of the present invention may also allow real-time full duplex videoconferencing over IP networks with built-in control for dynamic consistent bit-rate adjustments and quality of service control. Thus, at least some embodiments of the present invention allow for increased quality of service over standard Internet networks to that known in prior art techniques.

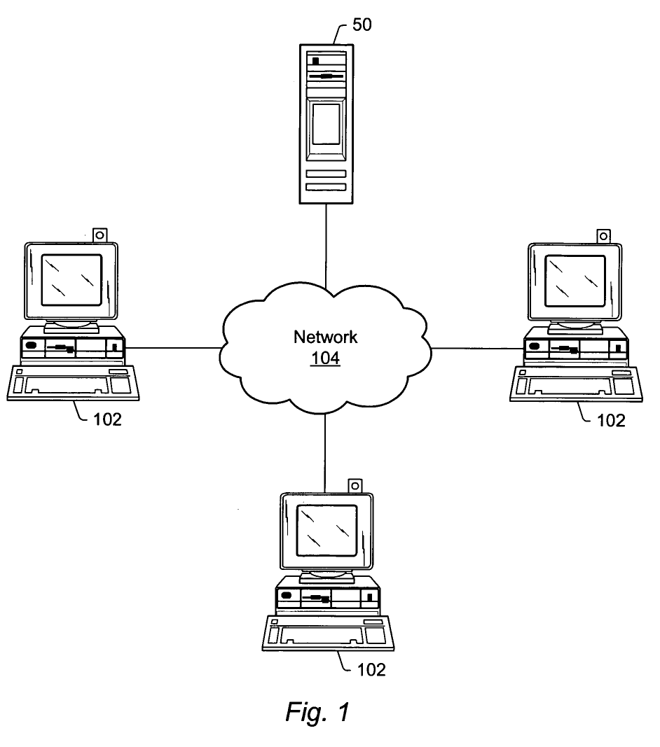

FIG. 1—Video Collaboration System

FIG. 1 illustrates a video collaboration system according to one embodiment of the invention. The video collaboration system of FIG. 1 is merely one example of a system which may use embodiments of the present invention. Embodiments of the present invention may be used in any of various systems which include transmission of data. For example, embodiments of the present invention may be used in any system which involves transmission of a video sequence comprising video images.

As shown in FIG. 1, a video collaboration system may comprise a plurality of client stations 102 that are interconnected by a transport medium or network 104. FIG. 1 illustrates 3 client stations 102 interconnected by the transport medium 104. However, the system may include 2 or more client stations 102. For example, the video collaboration system may comprise 3 or more client stations 102, wherein each of the client stations 102 is operable to receive audio/video data from the other client stations 102. In one embodiment, a central server 50 may be used to control initialization and authorization of a single or a plethora of collaboration sessions.

In the currently preferred embodiment, the system uses a peer-to-peer methodology. However, a client/server model may also be used, where, for example, video and audio data from each client station are transported through a central server for distribution to other ones of the client stations 102.

In one embodiment, the client stations 102 may provide feedback to each other regarding available or predicted network bandwidth and latency. This feedback information may be used by the respective encoders in the client stations 102 to compensate for the transport deficiencies across the Internet cloud 104.

As used herein, the term “transport medium” is intended to include any of various types of networks or communication mediums. For example, the “transport medium” may comprise a network. The network may be any of various types of networks, including one or more local area networks (LANs); one or more wide area networks (WANs), including the Internet; the public switched telephone network (PSTN); and other types of networks, and configurations thereof. In one embodiment, the transport medium is a packet switched network, such as the Internet, which may have dynamically varying bandwidths and latencies.

The client stations 102 may comprise computer systems or other similar devices, e.g., PDAs, televisions. The client stations 102 may also comprise image acquisition devices, such as a camera. In one embodiment, the client stations 102 each further comprise a non-visible light source and non-visible light detector for determining depths of objects in a scene.

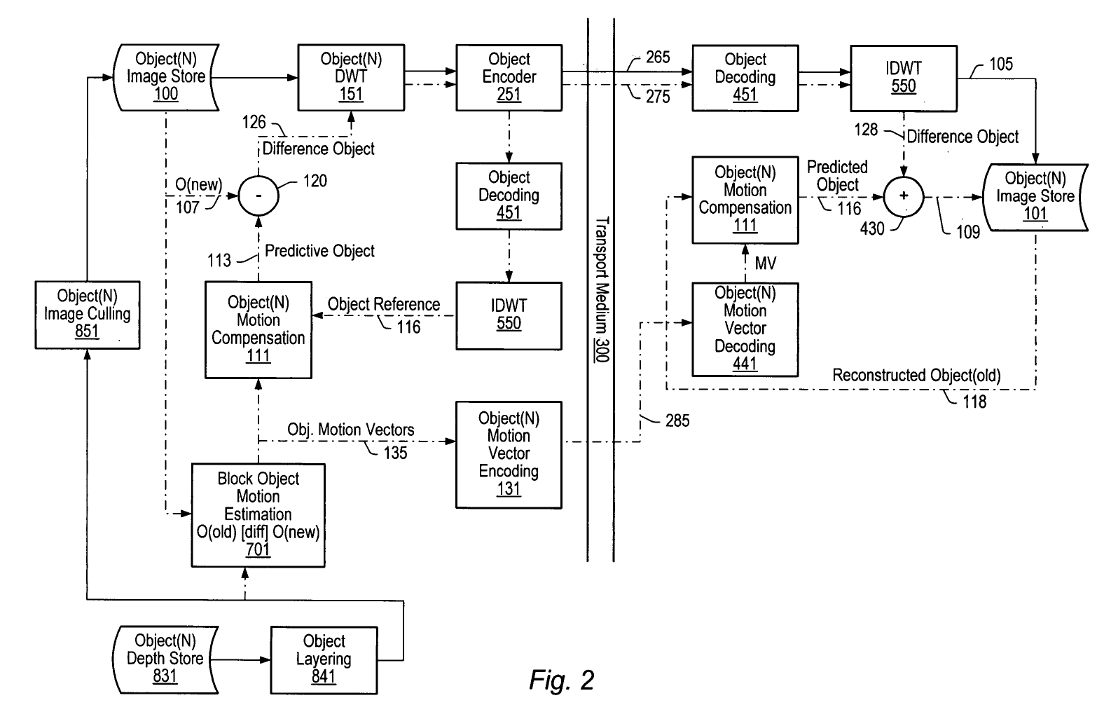

FIG. 2—Block Diagram of Video Encoding and Decoding Subsystems

FIG. 2 is an exemplary block diagram of one embodiment of a system. FIG. 2 illustrates a video encoding subsystem to the left of transport medium 300, and a video decoding subsystem to the right of the transport medium 300. The video encoding subsystem at the left of the transport medium 300 (left hand side of FIG. 2) may perform encoding of image objects for transport. The video decoding subsystem at the right of the transport medium 300 (right hand side of FIG. 2) may perform decompression and assembly of video objects for presentation on a display.

It is understood that a typical system will include a video encoding subsystem and a video decoding subsystem at each end (or side) of the transport medium 300, thus allowing for bi-directional communication. However, for ease of illustration, FIG. 2 illustrates a video encoding subsystem to the left of the transport medium 300 and a video decoding subsystem to the right of the transport medium 300.

In FIG. 2, each of the encoder and decoder subsystems is shown with two paths. One path (shown with solid lines) is for the intra frame (I-frame) encoding and decoding and the other path (shown with dashed lines) is for predictive frame encoding and decoding.

The system may operate as follows. First, an image may be provided to the video encoding subsystem. The image may be provided by a camera, such as in the video collaboration system of FIG. 1. For example, a user may have a camera positioned proximate to a computer, which generates video (a sequence of images) of the user for a video collaboration application. Alternatively, the image may be a stored image. The captured image may initially be stored in a memory (not shown) that is coupled to the object depth store queue 831. Alternatively, the captured image may initially be stored in the memory 100.

In one embodiment, the video encoding system includes a camera for capturing an image of the scene in the visible light spectrum (e.g., a standard gray scale or color image). The video encoding system may also include components for obtaining a “depth image” of the scene, i.e., an image where the pixel values represent depths of the objects in the scene. The generation of this depth image may be performed using a non-visible light source and detector. The depth image may also be generated using image processing software applied to the captured image in the visible light spectrum.

A plurality of image objects may be identified in the image. For example, image objects may be recognized by a depth plane analysis. In other words, in determining the 3-D space of the objects in the image, in one embodiment a methodology is used to determine the object depths and area positions. These depth and position values are stored in a depth store queue 831. Thus the image may be recognized in 3-D space. The object depth and position values may be provided from the depth store queue 831 as input to the object-layering block 841.

In one embodiment, all of the detectable image objects may be identified and processed as described herein. In another embodiment, certain of the detected objects may not be processed (or ignored) during some frames, or during most or all frames.

The object-layering block 841 references objects in the depth planes and may operate to tag objects in the depth planes and normalize the objects. The object-layering block 841 performs the process of object identification based on the 3D depth information obtained by the depth planes. Object identification comprises classification of an object or multiple objects into a range of depth planes on a “per-image or frame” basis. Thus, the output of the object layering method 841 is a series of object priority tags which estimate the span of the object(s) in the depth space (Z dimension). Object-layering 841 preferably normalizes the data values such that a “gray-scale” map comprising all the objects from a single or multiple averaged frame capture(s) have been adjusted for proper depth map representation. In addition, object identification may include an identity classification of the relative importance of the object to the scene. The importance of the various objects may be classified by the respective object's relative position to the camera in depth space, or by determination of motion rate of the respective object via feedback from the block object motion estimation block 701. Thus object-layering is used to normalize data values, clean up non-important artifacts of the depth value collection process and to determine layered representations of the objects identifying object relevance for further priority encoding. Thus, the object-layering block 841 provides prioritized and layered objects which are output to both the object motion estimation block 701 and the object image culling block 851.

The object image-culling block 851 is responsible for determining the spatial area of the 2-D image required by each object. The object image-culling block 851 may also assign a block grid to each object. The object image-culling block 851 operates to cull (remove) objects, i.e., to “cut” objects out of other objects. For example, the object image culling block 851 may operate to “cut” or “remove” foreground objects from the background. The background with foreground objects removed may be considered a background object. Once the object image-culling block 851 culls objects, the respective image objects are stored individually in the object image store 100. Thus the object image store 100 in one embodiment may store only objects in the image. In another embodiment, the object image store 100 stores both the entire image as well as respective objects culled from the image.

Thus, for an image which includes a background, a single user participating in the collaboration, a table, and a coffee mug, the object image block 841 and the object image culling block 851 may operate to identify and segregate each of the single user, the table, the coffee mug and the background as image objects.

The encoding subsystem may include control logic (not shown) which includes pointers that point to memory locations which contain each of the culled objects. The object image store 100 may store information associated with each object for registration of the objects on the display both in X/Y area and depth layering priority order. Object information (also called registration information) may include one or more of: object ID, object depth information, object priority (which may be based on object depth), and object spatial block boundaries, (e.g., the X/Y location and area of the object). Object information for each object may also include other information.

The following describes the compression of I frames (intra frames) (the solid lines of FIG. 2). I frames may be created for objects based on relative object priority, i.e., objects with higher priority may have I frames created and transmitted more often than objects with lower priority. In order to create the first intra frame, the object (which may have the highest priority) is sent to the object discrete wavelet transform block 151. The object DWT block 151 applies the DWT to an image object. Application of the DWT to an image object breaks the image object up into various sub bands, called “object sub bands”. The object sub bands are then delivered to the object encoder block 251.

In one embodiment, the object encoder block 251 uses various hierarchical quantization techniques to determine how to compress the sub bands to eliminate redundant low energy data and how to prioritize each of the object sub bands for transport within the transport medium 300. The method may compress the object sub bands (e.g., cull or remove object sub bands) based on the priority of the object and/or the currently available bandwidth.

The object encoder 251 generates packets 265 of Internet protocol (IP) data containing compressed intra frame object data and provides these packets across the transport medium 300. Object sub-bands are thus encoded into packets and sent through the transport medium 300. In the current embodiment the output packets 265 of compressed intra frame data are actually compressed individualized objects. Thus frames of compressed objects (e.g., I frames) are independently transmitted across the transmission medium 300. Compressed objects may be transmitted at varying rates, i.e., the compressed image object of the user may be sent more frequently than a compressed image object of the coffee mug. Therefore, in one aspect of the object compression, intra frame encoding techniques are used to compress the object sub bands that contain (when decoded) a representation of the original object.

As described further below, in the decoding process object sub-bands are summed together to re-represent the final object. The final object may then be layered with other objects on the display to re-create the image. Each individualized object packet contains enough information to be reconstructed as an object. During the decoding process, each object is layered onto the display by the object decoder shown in the right half of FIG. 2.

Thus, in one embodiment the encoder subsystem encodes a background object and typically multiple foreground objects as individual I-frame images. The encoded background object and multiple foreground objects are then sent over the transport medium 300 for assembly at the client decoder.

Again referring to FIG. 2, the intra frame (I frame) object decoding process is described. For each transmitted object, the intra frame object is first decoded by the object decoder 451. The object decoder 451 may use inverse quantization methods to determine the original sub band information for a respective individual object. Sub bands for the original objects are then input to the inverse discrete wavelet transform engine 550, which then converts the sub bands into a single object for display. The object 105 is then sent to the decoder's object image store 101 for further processing prior to full frame display. The above process may be performed for each of the plurality of foreground objects and the background object, possibly at varying rates as mentioned above.

The received objects are decoded and used to reconstruct a full intra frame. For intra frame encoding and decoding, at least one embodiment of the present invention reduces the number of bits required by selectively reducing sub bands in various objects. In addition, layered objects which are lower priority need not be sent with every new frame that is reconstructed. Rather, lower priority objects may be transmitted every few frames, or on an as-needed basis. Thus, higher priority objects may be transmitted more often than lower priority objects. Therefore, when decoded objects are being layered on the screen, a highest priority foreground object may be decoded and presented on the screen each frame, while, for some frames, lesser priority foreground objects or the one or more background objects that are layered on the screen may be objects that were received one or more frames previously.

The following describes the compression of predicted frames (P frames) (the dashed lines of FIG. 2). In one embodiment, predicted frames are constructed using motion vectors to represent movement of objects in the image relative to the respective object's position in prior (or possibly subsequent) intra frames or reconstructed reference frames. Predicted frames take advantage of the temporal redundancy of video images and are used to reduce the bit rate during transport. The bit rate reduction may be accomplished by using a differencing mechanism between the previous intra frame and reconstructed predictive frames. As noted above, predicted frames 275 reduce the amount of data needed for transport.

The system may operate to compute object motion vectors, i.e., motion vectors that indicate movement of an object from one image to a subsequent image. In one embodiment, 3-D depth and areas of objects are used for the determination and the creation of motion vectors used in creating predicted frames. In other words, motion vectors may be computed from the 3-D depth image, as described further below. Motion vectors are preferably computed on a per object basis. Each object may be partitioned into sub blocks, and motion vectors may be calculated for each of these sub blocks. Motion vectors may be calculated using motion estimation techniques applied to the 3-D depth image. The motion estimation may use a “least squares” metric, or other metric.

FIG. 2 illustrates one embodiment of how predictive frames can be constructed. As shown, the object layering block 841 provides an output to the block object motion estimation unit 701. In one embodiment, the block object motion estimation unit 701 uses a unique partitioning tree at different temporal resolutions for a fast evaluation during the comparison process and building of motion vectors 135.

In the construction of predictive frames, one embodiment of the invention uses several novel features, including the derivation of motion compensation information, and the application of depth and area attributes of individual objects to predictive coding. In one embodiment, a difference object 126 is built using the difference of an object reference 116 and a predictive object generated by the object motion compensation block 111. Block motion estimation for object layering is covered in detail later in this disclosure.

To determine the object reference 116, the local object under consideration for transport may be locally decoded. This inverse transform is preferably identical to the process used at the remote client decoder.

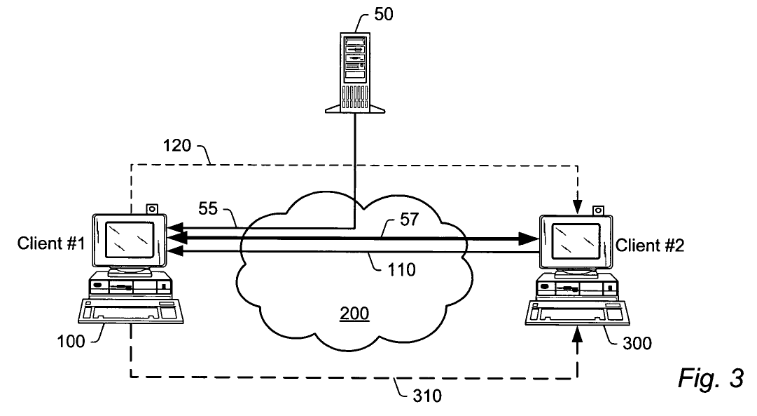

Again referring to FIG. 2 an image object that is to be predictively encoded (a particular predictive object 126 from a plurality of objects) is provided from the object image store 100 to the object DWT block 151. The discrete wavelet transform block 151 performs a discrete wavelet transform on the individual object. In one embodiment the output of the transform block 151 is a series of sub bands with the spatial resolution (or bounding box) of the individual object. In alternate embodiments the object bounds may be defined by an object mask plane or a series of polygonal vectors. The object encoder 251 receives the sub bands from the DWT block 151 and performs quantization on the respective predictive object. The quantization reduces the redundant and low energy information. The object encoder 251 of FIG. 3 is responsible for transport packetization of the object in preparation for transport across the transport medium 300. Thus, in one embodiment a unique encoder is used for the construction, compression and transport of predictive frames in the form of multiple sub bands across the transport medium.

In the decoding process, the motion compensation block 111 essentially uses the object motion vectors plus the reference object and then moves the blocks of the reference object accordingly to predict where the object is being moved. For example, consider an object, such as a coffee cup, where the coffee cup has been identified in 3D space. The coffee cup has relative offsets so it can be moved freely in 3D space. The object is also comprised of sub blocks of volume that have motion vectors that predict movement of the coffee cup, e.g., that it is going to deform and/or move to a new location. One can think of small “cubes” in the object with vectors that indicate movement of the respective cubes in the object, and hence represent a different appearance and/or location of the coffee mug. The object motion compensation block 111 receives the motion vectors from the block object motion estimation unit 701, and receives the previous object reference (how the object appeared last time) from the IDWT unit 550. The object motion compensation block 111 outputs a predictive object. The predictive object is subtracted from the new object to produce a difference object. The difference object again goes through a wavelet transform, and at least a subset of the resulting sub bands are encoded and then provided as a predictive object.

The decoder subsystem decodes a predictively encoded object as follows. After the remote (or local decoder) client receives the predictively encoded object, the object decoding block 451 performs inverse quantization on the object. Once the decoding block 451 restores the quantized information, the predictive object is transformed by the inverse discrete wavelet transform engine 550. The discrete wavelet transform engine 550 converts the objects sub bands back to a single predictive object 128, which is used with the accompanying object motion vectors to complete decompression of the predictive object.

In order to transform the predictive object back to its original form, the decoder subsystem further operates as follows. The decoder includes an object motion vector decoding block 441 which receives encoded motion vectors 285 over the transport medium 300. The object motion vector decoding block 441 decodes the objects encoded motion vectors and provides the decoded motion vectors to a motion compensation engine (object motion compensation block) 111. The motion compensation engine 111 reads the previous object (reconstructed object) 118 from the object image store 101 and the object motion vector information from the motion vector decoding block 441 and outputs a predicted object 116 to a summation block. The previous object and the object motion vector information establish a reference for the summation 430 of the currently decoded predictive object 116 with the difference object 128. The predicted object 116 and the difference object 128 are summed by the summation unit 430 to produce a decoded object 109. Thus the output of the summation unit 430 represents the decoded object 109. The decoded object 109, along with positioning information, priorities and control information, is sent to the object image store 101 for further processing and layering to the client display.

Therefore, in order to decode a stream of predictive objects, the remote decoding client receives object motion vectors 285 across the transport medium 300. The object motion vector decoding block 441 converts these into a reasonable construction of the original motion vectors. These motion vectors are then input to the object motion compensation block 111 and subsequently processed with the previous object retrieved from the object image store 101, rebuilding the new object for the display.

FIG. 3—Video Collaboration System with Feedback

FIG. 3 illustrates one embodiment of a system similar to FIG. 1 which may use embodiments of the present invention. FIG. 3 illustrates a system which includes two client systems or stations 102 communicating over a transport medium. In one embodiment, central server 50 may be used to control initialization and authorization of a single or a plethora of collaboration sessions. In one embodiment, the client stations 102 may provide feedback to each other regarding available or predicted network bandwidth and latency. This feedback information may be used by the respective encoders in the client stations 102 to compensate for the transport deficiencies across the Internet cloud 104.

In one embodiment a central server 50 is used to control initialization and authorization of a single or a plethora of collaboration sessions. A minimum session may comprise client 1 100 and client 2 300 communicating in a full duplex audio and video session. In alternate embodiments other types of sessions such as central server as know in the art may be instigated. In the preferred embodiment the system uses a peer-to-peer methodology. Client No. 1 100 will be considered the transmitter (encoder), and client No. 2, 300 will be considered the receiver (decoder) for the embodiment of FIG. 1. Transport channel 57 sends data over the Internet cloud 200. Within the system there are various feedback paths as shown by control input loop 120 from the client No. 1 100 to the client No. 2 300, and feedback loop 310 between the client No. 2, 300 and client No. 1, 100. In the preferred embodiment, and on initialization of the session between the clients, a history of session information is downloaded from the central server 50 over the Internet transport connection 55. This information comprises log files and transport delay history collected from previous sessions encountered between client No. 1, 100 and client No. 2, 300. Thus, it is desirable to use feedback control 310 and expected rate control 120 to compensate for the transport 57 deficiencies across the Internet cloud 200.

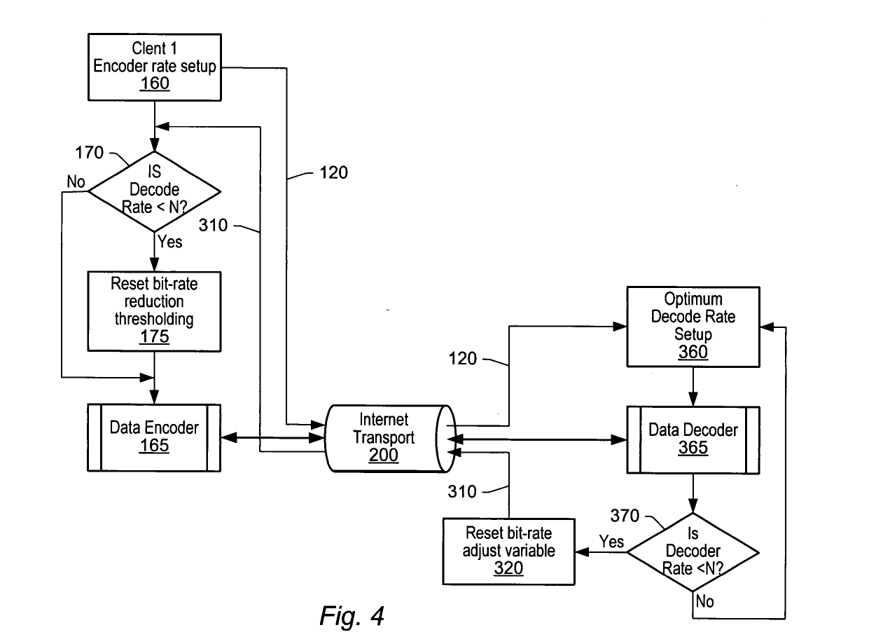

FIG. 4—Feedback Control Mechanism

FIG. 4 is a flow diagram of one embodiment of the feedback control mechanism between the encoder 100 and decoder 300. As shown in FIG. 4, step 160 indicates a rate set up for client No. 1. The rate set-up algorithm is determined to be the desired encoder frame-rate. This desired encoder rate is transmitted 120 over the Internet transport 200 and input to the optimum decoder rate set up block in step 360. The optimum rate, calculated by client 1's encoder rate set-up 160 is transported 120 to the decoder 360 and is used as a comparison to the actual rate at which the data decoder 365 can decode and display frames. The decoder 365 receives encoded data over the transport channel 57, and decodes the encoded data in preparation for output display. In step 370 a comparison is made between the desired rate from the encoder rate set-up step 160 and the actual rate the decoder 365 can achieve. The actual rate of the decoder output can be due to multiple components within the system. For the preferred embodiment the decoder output rate is assumed to be limited by the transport channel 57 and not to compute power of the decoder 635. In step 370 the decoder rate is compared to the desired rate 120 an if less than the desired frame rate then an adjustment must be made at the encoder 165 to adjust for the Internet Transport 200 rate. The process continues to step 320 where a variable is set to re-initialize encoder bit rate to compensate for the Internet transport 200 latency or bandwidth. The Bit-Rate adjust variable set in step 320 is transport 310 across the Internet channel 200 and received by the encoder for processing in step 170. Step 170 of the encoder examines decoder rate variable and if less than it's desired frame rate (N) proceeds to step 175. In Step 175 a bit rate reduction process sets various threshold settings to vary for the encoder to compensate for the transport latencies or bandwidth limitations. If in step 170 it is determined that the decoder has achieved the desired rate, the process continues to 165 were data is encoded under the same assumptions and expectations as desired and previously set by step 160. The expectations of course are to continue at the desired encoding frame rate of N frames per second.

In alternate embodiments the decode frame rate adjustments may be performed for independent objects as well as completed frames of objects. In the preferred embodiment of the present invention the desired frame rate is for complete frames assembled of multiple or single objects.

In one embodiment the system assumes the lowest common denominator for transport rate. In an alternate embodiment, the encode IP channel selector is used to adjust for optimum transport for each individual client. In this embodiment all clients are set to accommodate the lowest performance channel.

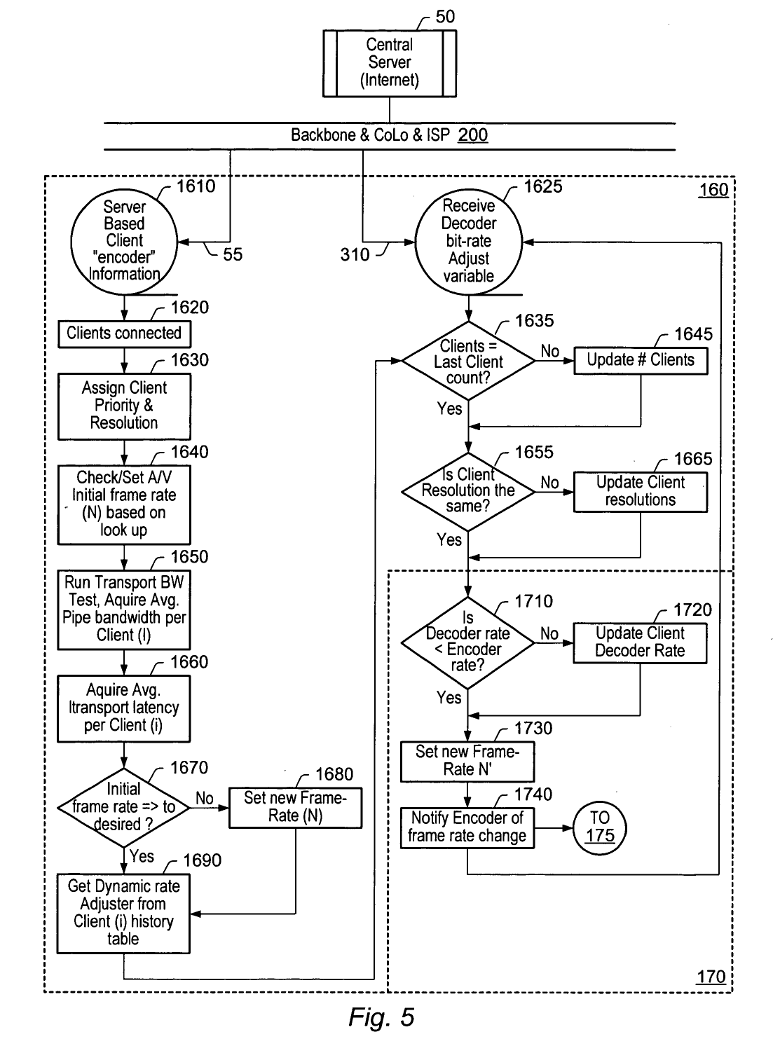

FIG. 5

In addition to desired frame rate adjustment, in one embodiment, multiple variables are examined to determine the proper encoding rate for the system. FIG. 5 is a detailed diagram showing the additional consideration of system performance, bandwidth allotment, screen resolution, desired frame rate, number of clients in a session and the history of transport from previous sessions. Now referring to FIG. 5 a central server 50 is used to authenticate and initiate session control between multiple clients. The embodiment described herein shows only two clients, one encoder and one decoder. In alternate embodiments there may exist a plurality of clients each using the system attributes described in FIG. 5 for bit rate control. Here it is assumed that a central server 50 is connected to the Internet backbone network 200, and information 55 from the central server 50 sets up the encoding client (step 1610) with all the necessary encoder information.

After the base client encoder information is set in step 1610 the process proceeds to step 1620 where the number of clients connected into the session is determined. In step 1630 the system assigns the client priority and resolution of the display. In one embodiment step 1640 determines the initial frame rate as set by the local client. The process proceeds to step 1650 where the Internet transport bandwidth is tested to acquire the average bandwidth for each of the clients in the session. Once the bandwidth of each client channel is determined by Internet transport test, the process proceeds to step 1660 where a latency test determines each of the client's average latency for transport from the encoder to each decoder in the session. As seen in step 1670 the above information from step 1650 and 1660 are used to set the initial frame rate and determine if the measured latency and bandwidth can achieve the desired frame rate of the encoder. If the measured bandwidth and latency cannot meet the desired frame rate, the process continues to step 1680 where the new frame rate is set. Step 1690 is entered when the desired frame rate can be achieved. The transport mechanism in step 1690 and lookup table downloaded by a central server 50 is also used to determine the correct dynamic rate for the encoder.

Steps 1610 through 1690 can be considered static initialization setup steps. Now proceeding with the dynamic runtime operation, in step 1625 input from the client decoders through transport 310 sets the decoder bit rate for each of the clients. The decoder bit rate adjust variable is used throughout to set the encoder's target bit rate. As indicated in FIG. 5, the two outlined sections labeled 160 and 170 represent a detailed diagram of FIG. 4, where section 160 corresponds to the encoder rate setup and section 170 corresponds to the decoder rate comparison block.

Again referring to FIG. 5, process continues to steps 1635 where the number of clients is examined continuously, in case new clients join or original clients leave the session. If the count of clients is not equal to the last count, the method continues to step 1645 where the new client count is updated and stored. If no new clients have joined, the method continues to step 1655 were the process examines the client display resolutions. If the client resolutions have changed, process continues to 1665 were each client display resolution is updated to reflect the new values. Assuming that no clients have changed resolution the process continues with step 1710 where a comparison is made to determine if the decoder rate is less than the preferred encoder rate. Assuring that the decoder rate is equal to or greater than the desired rate, the process continues to step 1720 where the decoder rate is updated and the test repeats itself dynamically once again in step 1625. Assuming that the decoder does not have enough information to decode and display at the desired rate, the process continues to 1730 where the new frame rate (N) is set. In step 1740 the encoder is notified that a frame rate change and a bit rate adjustment should be made. The process continues to step 175 of FIG. 4.

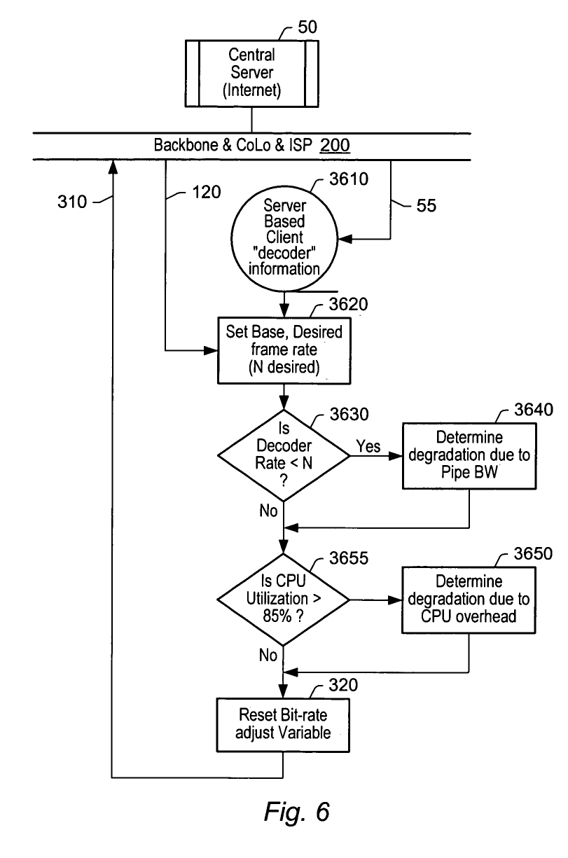

FIG. 6 is a detailed diagram of the decoder process. Once again a central server 50 is connected to the backbone of the Internet 200 with connections to the decoding client. In the embodiment of FIG. 6, only a single client is shown. In alternate embodiments a multiplicity of decoder clients may be present. Set up in the central server 50 to the decoding client 3610 sends control information 55 to the transport medium 200. At step 3620 the method receives the desired encoder bit rate (N) 120 from the transport medium 5 200 and stored locally at the decoder site. The process continues with step 3630 where a comparison is made between the actual decoder frame rate and that of the desired, previously stored, encoder rate. If the decoder rate is less than the desired rate (N), the process continues with step 3640, where a rate test is made to determine the degradation due to the Internet transport bandwidth. In step 3640 the degradation value is temporarily stored for use later. The process continues with step 3655 were a determination is made on the CPU utilization based on the decoding, encoding, resolution, and number of clients. If it is determined the CPU is taxed to at least 85 percent, the process continues to step 3650. In step 3650 a determination of the degradation due to the CPU load is made. The process then returns to step 320 where the bit rate adjust variable is set based on the results of step 3640 and step 3650. The bit rate adjust variable 310 is sent to the transport medium 200 where it is eventually received by the encoder as indicated in FIG. 2.

Referring again to FIG. 4, if it is determined that the decoder rate is less than the desired frame rate 170 (N) then adjustment is preferably made to minimize the bit rate from the encoder 165 to the transport medium 200. This is preferably accomplished using discrete wavelet transforms. In alternate embodiments the reduction of information can be accomplished by other compression techniques such as discrete cosine transforms or the four squares process. Here the object is to reduce the information sent over the transport medium 200, e.g., by reduction of sub bands after a wavelet transform function, by the change in quantization levels in a cosine transform, etc. Encoder Step 170 of FIG. 4 awaits a response 310. If it is determined that more quantization or fewer sub bands should be sent across transport medium 200, then another adjustment is made to the encoder 165. If it is determined that the previous reduction in bit rate coming from the data encoder and 65 has satisfied the desired frame rate, the bit rate ceiling is increased and other dynamic adjustment by the encoder 165 and can be made.

Thus, the system determines the optimum dynamic amount of compensation as directed by feedback from the decoder to the encoder where the encoder dynamically adjusts the transport bit rate for reception at the receiver. The system adjusts compressed data rates for not only frames, but independent objects as well. Therefore, a finer granular adjustment to the bit rate based on the priority of individual objects that make up an entire frame can be achieved. It is therefore shown that embodiments of the invention substantially improve the quality and adjust for transport deficiencies during the transport of media information over the Internet protocol system.

Therefore, embodiments of the present invention significantly compensate for transport bit rate and image quality when used for the transport of video imagery across Internet networks.

We claim:

1. A method for transferring data over a network, the method comprising:
a decoder process determining parameters of a network connection, including one or more of current or predicted bandwidth and/or latency;
providing information regarding the determined parameters to an encoding process;
the encoding process receiving the information regarding the determined parameters;
the encoding process setting one or more of rank and prioritization of independent objects to be compressed by the encoding process based at least in part on the information regarding the determined parameters;
the encoding process generating and transmitting compressed objects at one or more of varying rates and varying amounts of compression based on said one or more of rank and prioritization of independent objects to be compressed.

2. The method of claim 1,
wherein the encoding process generates varying amounts of compression utilizing a discrete wavelet transform.

3. The method of claim 1,
wherein if the network parameters indicate that network bandwidth has increased and/or transfer latency has decreased, the encoder process generating and transmitting comprises performing at least one of 1) transmitting a greater number of compressed objects and/or 2) transmitting compressed objects with a reduced amount of compression;
wherein if the network parameters indicate that network bandwidth has decreased and/or transfer latency has increased, the encoder process generating and transmitting comprises performing at least one of 1) transmitting a lesser number of compressed objects and/or 2) transmitting compressed objects with a greater amount of compression.

4. The method of claim 1,
wherein the decoder process determines parameters of the network connection based at least one prior transmission of the encoding process to the decoding process.

5. The method of claim 1,
wherein the decoder process determines parameters of the network connection based at least one prior transmission of each of a plurality of encoding processes to the decoding process.

6. The method of claim 1,
wherein the network is an Internet Protocol (IP) network.

7. A method for performing an encode and decode of video data for transport over computer networks, the method comprising:
a decoder process determining parameters of a network connection, including one or more of current or predicted bandwidth and/or latency;
providing information regarding the determined parameters to the encoding process;
the encoding process receiving the information regarding the determined parameters;
the encoding process setting one or more of rank and prioritization of independent objects to be compressed by the encoding process based at least in part on the information regarding the determined parameters;
the encoding process generating and transmitting compressed objects at varying rates and/or with varying amounts of compression based on said one or more of rank and prioritization of independent objects to be compressed.

8. A method for performing an encode and decode of video data for transport over computer networks, the method comprising;
an input device generating an uncompressed video stream, wherein the uncompressed video stream comprises one or more independent video objects comprised of spatial and temporal differences of uncompressed data;
an encoder compressing the one or more independent video objects to produce one or more compressed video objects;
the encoder transmitting the one or more compressed video objects to one or more remote receivers across a network;
the one or more receivers receiving said one or more compressed video objects;
at least one remote receiver determining parameters of the network based on the transport of previously compressed video objects through the network;
the at least one remote receiver generating a signal indicative of the parameters of the network;
the at least one remote receiver transmitting the signal indicative of the parameters of the network to the encoder;
the encoder dynamically adjusting an output bit rate of newly compressed video objects based on the signal indicative of the parameters of the network.

9. The method of claim 8,
wherein the one or more remote receivers comprise a plurality of remote receivers;
wherein each of the plurality of remote receivers performs said determining parameters, said generating a signal, and said transmitting the signal to the encoder;
wherein the encoder dynamically adjusts an output bit rate of newly compressed video objects based on a plurality of signals indicative of the parameters of the network received from respective ones of the plurality of receivers.
